(19) United States
(12) Patent Application Publication
(10) Pub. No.: US 2012/0003566 A1
(43) Pub. Date: Jan. 5, 2012

(54) FUEL CARTRDIGE FOR FUEL CELL

(75) Inventors: Young-Seung NA, Yongin-si (KR); Seong-Kee YOON, Yongin-si (KR); Young-Jae KIM, Yongin-city (KR); Lei HU, Yongin-city (KR)

(73) Assignee: SAMSUNG SDI CO., LTD., Yongin-si (KR)

(21) Appl. No.: 13/161,265

(22) Filed: Jun. 15, 2011

(30) Foreign Application Priority Data
Jun. 30, 2010 (KR) 10-2010-0062881

(51) Int. Cl. H01M 8/04

(52) U.S. Cl. 429/515

(57) ABSTRACT

A fuel cartridge for a fuel cell capable of accurately measuring the residual amount of fuel is disclosed. A fuel cartridge for a fuel cell may include a housing and a pouch contained within the housing and forming an inner space. The inner space of the pouch is formed by mechanically connecting a first plane portion and a second plane portion parallel to each other with a side portion intersecting both the first plane portion and the second plane portion. The pouch may be configured to contract or expand according to a residual amount of fuel in the inner space. The pouch may include a fuel path formed on the upper portion thereof. First and second electrodes may be positioned facing each other at opposite sides of the side portion with the pouch in the housing positioned therebetween when viewed in a plane. The first electrode and the second electrode may also have a plurality of opposite directions.

### CROSS-REFERENCE TO RELATED APPLICATIONS

This application claims priority to and the benefit of Korean Patent Application No. 10-2010-0062881 filed in the Korean Intellectual Property Office on Jun. 30, 2010, the entire contents of which are incorporated herein by reference.

### BACKGROUND

1. Field of the Disclosure

The described technology relates generally to a fuel cartridge for a fuel cell that measures residual amount of fuel remaining in a pouch.

2. Description of the Related Technology

A fuel cell power supply system receives fuel for power generation from a fuel supply contained within a fuel container. When the fuel in the fuel container gets low, the fuel container is replaced with a new fuel container. This process often leaves a residual amount of fuel in the fuel container. Various methods exist for detecting whether a liquid remains in a container. Such methods include photo sensor, resistive detection, and capacitive methods.

In the photo sensor method, a photo sensor detects the presence of liquid by positioning a light source and a light receiving device on opposite sides of a liquid and measuring changes in the amount of light. In the resistive detection method, the system detects the presence of liquid by positioning electrodes on either side of a liquid and measuring changes in resistance. In the capacitive method, the system detects the presence of liquid by positioning electrodes on either side of a liquid and measuring changes in capacitance between the electrodes. In each case, a sensing unit, that is, a light source and a light receiving device, an electrode for detecting resistance, or an electrode for measuring capacitance are installed in a fuel container. When the fuel container is not maintained at a fixed state and the fuel container inclines in a specific direction, the shape of the fuel in the fuel container may change. Thus, the relative position of the fuel to the sensing unit may change. Thereby, discrepancies occur between a residual amount in the fuel container and the residual amount measured by the sensing unit.

### SUMMARY OF CERTAIN INVENTIVE ASPECTS

In one aspect, a fuel cartridge for a fuel cell is provided, which is capable of accurately measuring the residual amount of fuel even when the relative position of fuel to an electrode is changed.

In another aspect, a fuel cartridge is provided, which is capable of accurately measuring a residual amount of fuel when the fuel cartridge is inclined or overturned.

In another aspect, a fuel cartridge for a fuel cell includes, for example, a housing and a pouch contained within the housing. In some embodiments, the pouch forms an inner space by connecting a first plane portion and a second plane portion parallel with each other to a side portion intersecting therewith. In some embodiments, the pouch is configured to contract or expand according to a residual amount of fuel contained within the inner space. In some embodiments, the pouch forms a fuel path on the upper portion thereof. In some embodiments, a fuel cartridge for a fuel cell further includes first and second electrodes positioned at opposite sides of the side portion and facing each other with the pouch in-between when viewed in a plane. In some embodiments, the first electrode and the second electrode have a plurality of opposite directions.

In some embodiments, the first plane portion and the second plane portion are each formed in a rectangular shape. In some embodiments, the pouch forms a variable rectangular parallelepiped. In some embodiments, the first electrode includes, for example, a first long side portion formed in a plate shape and positioned at first long sides of the first plane portion and the second plane portion, and a first short side portion formed in a plate shape and mechanically connected to the first long side portion at a right angle. In some embodiments, the first short side portion is positioned at a first short side of the first plane portion and the second plane portion. In some embodiments, the second electrode includes, for example, a second long side portion formed in a plate shape positioned at second long sides of the first plane portion and the second plane portion and positioned to face the first long side portion, and a second short side portion formed in a plate shape mechanically connected to the second long side portion at a right angle. In some embodiments, the second short side portion is positioned at the second short portion of the first plane portion and the second plane portion. In some embodiments, the second short side portion is positioned to face the first short side portion.

In some embodiments, the first electrode includes, for example, an eleventh long side portion and a twelfth long side portion each formed in a plate shape and positioned at a side of a first long side and a second long side of the first plane portion and the second plane portion, respectively, and a first short side portion formed in a plate shape mechanically connected to the eleventh long side portion and the twelfth long side portion at a right angle and is positioned at the first short sides of the first plane portion and the second plane portion. In some embodiments, the second electrode includes, for example, a twenty-first long side portion and a twenty-second long side portion each formed in a plate shape and positioned at the first long side and the second long side of the first plane portion and the second plane portion at an opposite side of the first short side portion and face each of the eleventh long side portion and the twelfth long side portion, and a second short side portion formed in a plate shape mechanically connected to the twenty-first long side portion and the twenty-second portion at a right angle and positioned at the second short sides of the first plane portion and the second plane portion and face the first short side portion.

In some embodiments, the first electrode and the second electrode form a first capacitor. In some embodiments, the fuel stored in the pouch is positioned between the first electrode and the second electrode at approximately the middle of the side portion. In some embodiments, the first electrode and the second electrode further includes, for example, a second capacitor and a third capacitor. In some embodiments, the second capacitor and the third capacitor are each formed with air between the first electrode and the second electrode at the first plane portion side and the second plane portion side of the pouch. In some embodiments, the plurality of opposite directions includes a first opposite direction parallel with the first plane portion and the second plane portion, and a second opposite direction parallel with the first plane portion and the second plane portion and intersects with the first opposite direction.

In another aspect, a fuel cartridge for a fuel cell includes, for example, a pouch that connects a pair of plane portions parallel with each other to a side portion intersecting therewith to form an inner space in a shape of a polygonal column. In some embodiments, the pouch is configured to contract or expand according to a residual amount of fuel in the inner space. In some embodiments, the fuel cartridge for a fuel cell further includes, for example, a first electrode and a second electrode positioned at opposite sides of the side portion facing each other with the pouch positioned therebetween. In some embodiments, the first electrode and the second electrode have a plurality of opposite directions. In some embodiments, at least one of the first electrode and the second electrode is positioned at an entire side of the pair of plane portions.

In some embodiments, the polygonal column shape is formed in one of a triangular column, a quadrangular column, a pentagonal column, and a hexagonal column. In some embodiments, the pouch is formed in a triangular column and forms the plane portion in a triangular shape having a first side, a second side, and a third side that are sequentially disposed. In some embodiments, the first electrode is positioned at the first side and the second side. In some embodiments, the second electrode is positioned at the third side. In some embodiments, the second electrode is further positioned at the second side. In some embodiments, the pouch is formed in a pentagonal column and forms the plane portion in a pentagonal shape having a first side, a second side, a third side, a fourth side, and a fifth side that are sequentially disposed. In some embodiments, the first electrode is positioned at the first side, the second side, and the third side. In some embodiments, the second electrode is positioned at the fourth side and the fifth side. In some embodiments, the second electrode is further positioned at the third side. In some embodiments, the pouch is formed in a hexagonal column and forms the plane portion in a hexagonal shape having a first side, a second side, a third side, a fourth side, a fifth side, and a sixth side that are sequentially disposed. In some embodiments, the first electrode is positioned at the first side, the second side, and the third side. In some embodiments, the second electrode is disposed at the fourth side, the fifth side, and the sixth side.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a perspective view of a fuel cartridge for a fuel cell according to a first exemplary embodiment.

FIG. 2 is a perspective view of a pouch of FIG. 1.

FIG. 3 is a cross-sectional view taken along line of FIG. 1.

FIG. 4 is a plan view of FIG. 1.

FIG. 5 is an equivalent circuit view of a capacitor formed between electrodes of FIG. 1.

FIG. 6 is a graph showing the relationship between the residual amount of the fuel and capacitance in the fuel cartridge of FIG. 1.

FIG. 7 shows the relationship between the residual amount and the capacitance when fuel is discharged and injected in the state where the fuel cartridge of FIG. 1 overturns.

FIG. 8 shows a graph showing the relationship between residual amount and capacitance when the fuel is discharged and injected in the state where the pouch of FIG. 1 overturns.

FIG. 9 is a perspective view of a fuel cartridge for a fuel cell according to a second exemplary embodiment.

FIG. 10 is a cross-sectional view taken along line X-X of FIG. 9.

FIG. 11 is a plan view of FIG. 9.

FIG. 12 is a plan view of a fuel cartridge for a fuel cell according to a third exemplary embodiment.

FIG. 13 is a plan view of a fuel cartridge for a fuel cell according to a fourth exemplary embodiment.

FIG. 14 is a plan view of a fuel cartridge for a fuel cell according to a fifth exemplary embodiment.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Similarly, when it is described that an element is “coupled” to another element, the another element may be “directly coupled” to the other element or “electrically coupled” to the other element through a third element. Parts not related to the description are omitted for clarity. Hereinafter, like reference numerals refer to like elements. Certain embodiments will be described in more detail with reference to the accompanying drawings, so that a person having ordinary skill in the art can readily make and use aspects of the present disclosure.

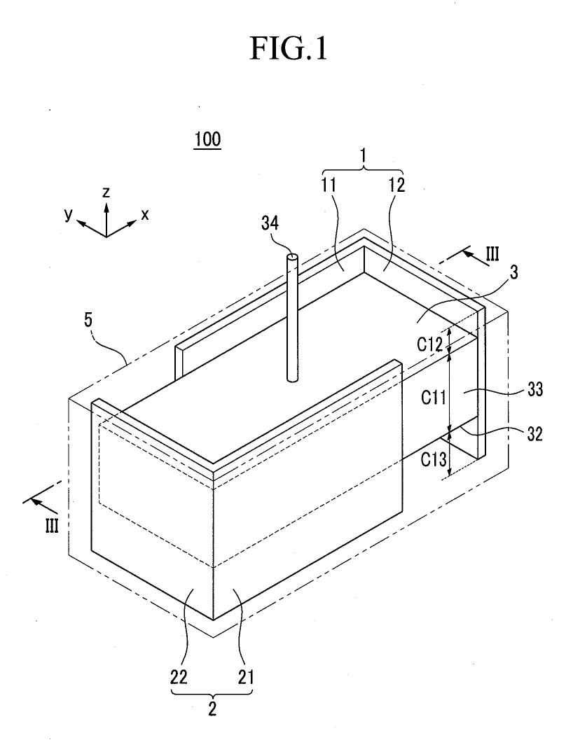

FIG. 1 is a perspective view of a fuel cartridge for a fuel cell according to a first exemplary embodiment. Referring to FIG. 1, a fuel cartridge 100 (hereinafter, referred to as “fuel cartridge”) for a fuel cell includes a housing 5, a pouch 3 positioned within the housing 5 and filled with fuel, and a first electrode 1 and a second electrode 2 disposed at opposite sides of the pouch 3, positioning the pouch 3 in the housing 5 therebetween.

The pouch 3 may have a flexible structure. The housing 5, however, has a more rigid structure and forms an external casing of the fuel cartridge 100, thereby protecting the pouch 3 from an external environment such as from impact or heat. As shown in FIG. 1, the housing 5 may be formed with a rectangular parallelepiped shape.

The first and second electrodes 1 and 2 are disposed at opposite sides of the pouch 3 to form a capacitor with the fuel or air therebetween. Therefore, the fuel cartridge 100 is configured to measure a change in capacitance between the first and second electrodes 1 and 2 and configured to determine the fuel amount remaining in the pouch 3. For example, when the pouch 3 is completely filled with fuel between the first and second electrodes 1 and 2, the first and second electrode 1 and 2 form a single capacitor with fuel positioned therebetween. When the pouch 3 is partially filled with fuel in between the first and second electrodes 1 and 2, three capacitors are formed using the first and second electrodes 1 and 2 air, fuel, and air positioned therebetween. Thus, three capacitors are formed in a parallel structure between the first and second electrodes 1 and 2.

The shape of the housing 5, the pouch 3 and the first and second electrodes 1 and 2 may be properly selected according to the devices or places in which the fuel cartridge 100 is used and forms the mutual corresponding structure. For example, the housing 5 and the pouch 3 may be formed in a rectangular parallelepiped shape and the first and second electrodes 1 and 2 may be formed to have a right angle in a plate shape facing the rectangular parallelepiped shape. The first and second electrodes 1 and 2 face each other to surround the side of the pouch 3.

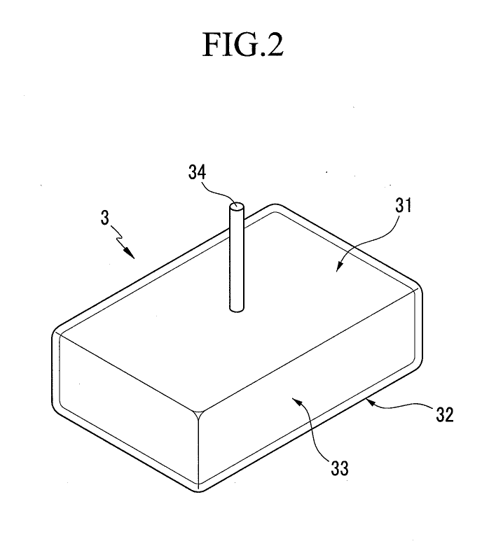

FIG. 2 is a perspective view of the pouch of FIG. 1. Referring to FIG. 2, the pouch 3 may be formed of flexible materials. The pouch 3 forms the rectangular parallelepiped shape that can be positioned within the housing 5 in the state where internal pressure is not applied. When the amount of fuel remaining in the pouch is reduced, the pouch may contract into a shape other than a rectangular parallelepiped shape. The shape may be determined by gravity although the pouch does maintain an approximate rectangular parallelepiped shape. In other words, the pouch 3 has a variable rectangular parallelepiped shape. For convenience, the pouch 3 is described with reference to the rectangular parallelepiped shape without the slight modifications that may occur when the amount of fuel in the pouch is reduced.

The pouch 3 includes a first plane portion 31 and a second plane portion 32 that are positioned in parallel with each other. The pouch 3 also includes a side portion 33 mechanically connecting the first and second plane portions 31 and 32 to each other. For example, when the fuel cartridge 100 maintains a normal state as shown in FIG. 1, the first plane portion 31 is disposed on the upper portion and the second plane portion 32 is positioned on the lower portion thereof. The first and second plane portions 31 and 32 and the side portion 33 are formed of a flexible material such as polyethylene, such that the first and second plane portions 31 and 32 and the side portion 33 may be contracted and expanded according to an amount of fuel remaining in the inner space of the pouch 3.

The side portion 33 is mechanically connected to the first and second plane portions 31 and 32 and positioned approximately orthogonal to the first and second plane portions 31 and 32, thereby forming the inner space of the pouch 3. In other words, the first and second plane portions 31 and 32 form an xy plane and the side portion 33 forms a width in a z-axis direction. The side portion 33 may therefore be formed to include the entire length of sides mechanically connecting the first and second planes 31 and 32.

The pouch 3 includes a connector 34, which is configured to provide a fuel path for discharging fuel from the inner space to the fuel cell (not shown) or when the fuel is injected into the inner space of the pouch. For example, one end of the connector 34 may be in fluid communication with approximately the middle of the first plane portion 31 or the second plane portion 32 and another end of the connector 34 may be in fluid communication with a fuel pump (not shown).

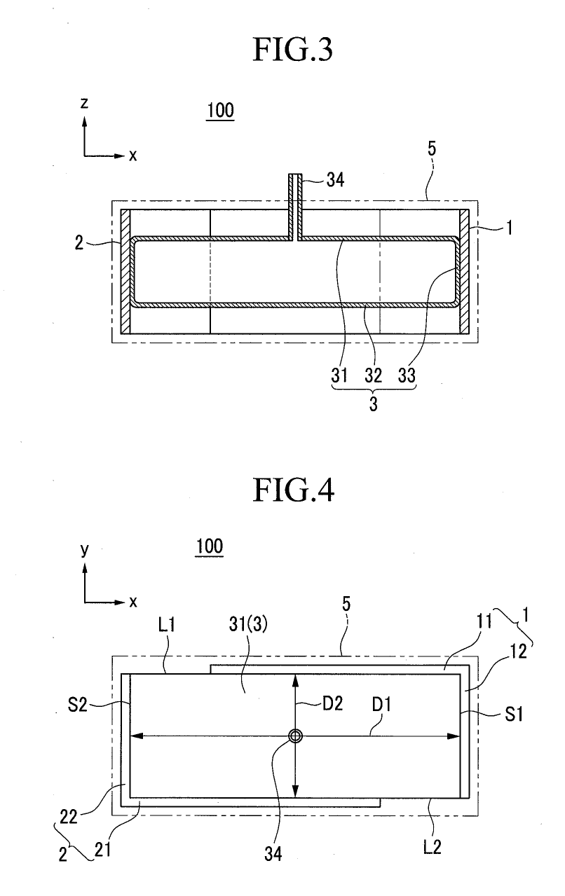

FIG. 3 is a cross-sectional view taken along line of FIG. 1 and FIG. 4 is a plan view of FIG. 1. Referring to FIG. 4, the first and second electrodes 1 and 2 face each other at opposite sides and corners of the side portion 33 of the pouch 3 when being viewed from the plane. In this case, the opposite direction is formed in plural (both in a first opposite direction D1 and in a second opposite direction D2). FIG. 4 shows the two first and second opposite directions D1 and D2, respectively.

The first opposite direction D1 (x-axis direction) is parallel with the first and second plane portions 31 and 32. The second opposite direction D2 (y-axis direction) is parallel with the first and second plane portions 31 and 32 and is set as a direction orthogonal to the first opposite direction D1. The first and second electrodes 1 and 2 face each other when being viewed from each surface of the side portions 33 of the pouch 3. Therefore, even when the fuel cartridge 100 is inclined in a specific direction, fuel is positioned between the first and second electrodes 1 and 2, thereby making it possible to measure the residual amount of fuel.

For better comprehension and ease of description, the first and second plane portions 31 and 32 of the pouch 3 will be described in detail. For convenience of explanation, the first and second plane portions 31 and 32 are formed to have the same sized rectangular shape and have the first and second long sides L1 and L2 facing each other and the first and second short sides S1 and S2 facing each other while being orthogonal thereto. In some embodiments, however, the first and second plane portions 31 and 32 do not have identically sized rectangular shapes.

The first electrode 1 is formed in a plate shape to include the first long side portion 11 and the first short side portion 12, which are mechanically connected to each other at a right angle. The first long side portion 11 is disposed at the first long sides L1 of the first and second plane portions 31 and 32. The first short portion 12 is disposed at a first short side S1 of the first and second plane portions 31 and 32. The second electrode 2 is also formed in a plate shape and includes the second long side portion 21 and the second short side portion 22, which are mechanically connected to each other at a right angle. The second long side portion 21 is disposed at a second long side L2 of the first and second plane portions 31 and 32 to face the first long side portion 11. The second short portion 22 is disposed at the second short side S2 of the first and second plane portions 31 and 32 to face the first short side portion 12. The first and second long side portions 11 and 21 of the first and second electrodes 1 and 2 are thus positioned and configured to measure capacitance by facing each other in the second opposite direction D2 at the first and second long sides L1 and L2 of the pouch 3. Similarly, the first and second short side portions 12 and 22 of the first and second electrodes 1 and 2 are positioned and configured to measure capacitance by facing each other in the first opposite direction D1 at the first and second short sides S1 and S2 of the pouch 3.

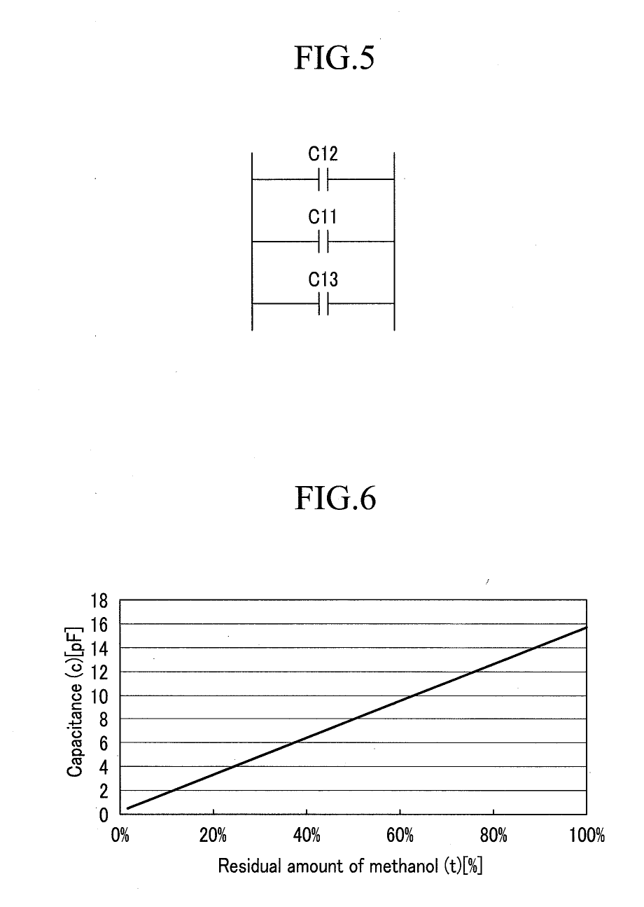

FIG. 5 is an equivalent circuit diagram of a capacitor formed between the electrodes of FIG. 1. In FIGS. 3 and 5, the first and second electrodes 1 and 2 form the first capacitor C11, with fuel stored in the pouch 3 approximately at the middle of the side portion 33 therebetween. In other words, the first capacitor C11 is formed between the first and second long side portions 11 and 21 and the first and second short side portions 12 and 22 that correspond to about the middle of the side portion 33.

The first and second electrodes 1 and 2 form the second capacitor C12 and the third capacitor C13 using air positioned on either side of the first capacitor C11. That is, the second and third capacitors C12 and C13 are formed between the first and second long side portions 11 and 21 and the first and second short side portions 12 and 22 corresponding to both sides of the first and second plane portions 31 and 32 of the side portion 33. Thus, when the amount of fuel in the pouch 3 is reduced, the first and second electrodes 1 and 2 and the pouch 3 are spaced from each other such that air may be interposed therebetween. In addition, the side portion 33 of the pouch 3 and the first and second electrodes 1 and 2 are spaced from each other to interpose air therebetween while the second plane portion 32 of the pouch 3 is depressed by gravity in a direction along the z-axis of FIG. 1. Therefore, the first capacitor C11 forms a capacitor having a serial structure such as the first electrode 1, air, fuel, air, the second electrode 2. In this case, the capacitance C1 for fuel may be calculated by accounting for the capacitance of air.

The entire capacitance C measured between the first and second electrodes 1 and 2 is calculated by the sum of the capacitance C1 for fuel and the capacitance C2 and C3 for air (see Equation 1).

C=C1+(C2+C3)=e0×e1×t×W×L/d+(e0×e2×(1−t)×W×L/d) Equation 1

In Equation 1, e0 is a dielectric constant in a vacuum state, e1 is a dielectric constant of methanol that is fuel, e2 is a dielectric constant of air, t is a percentage of fuel residual amount of fuel with respect to the entire fuel amount and is larger than 0 and smaller than 1, W×L is an opposite area (width×length) of the first and second electrodes 1 and 2, and d is a distance between the first and second electrodes 1 and 2 set in an opposite direction.

In Equation 1, the percentage (t) of the residual amount of fuel is variable and the rest is constant. Therefore, the entire capacitance C is determined according to the residual amount of fuel, such that the fuel amount remaining the pouch 3 can be appreciated according to the capacitance C.

FIG. 6 is a graph showing the relationship between the residual amount of the fuel and capacitance of FIG. 1. Referring to FIG. 6, it can be appreciated that the residual amount (%) of methanol that is fuel and the change of capacitance C is linearly shown in the fuel cartridge 100.

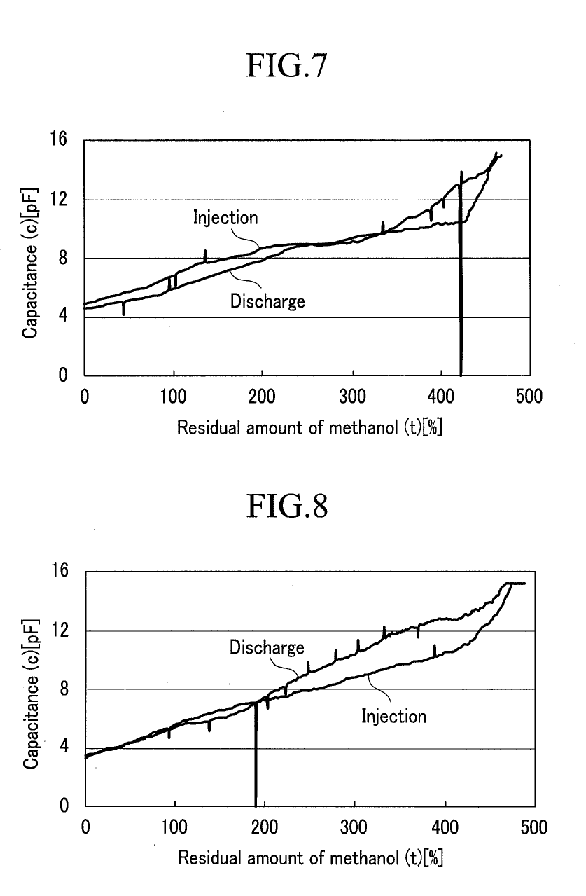

FIG. 7 shows the relationship between a residual amount of methanol and the capacitance when fuel is discharged and injected in the state where the fuel cartridge of FIG. 1 overturns. Referring to FIG. 7, when fuel is discharged from or is injected into the pouch 3 in the state where the fuel cartridge 100 overturns, it can be appreciated that the residual amount of methanol that is fuel and the change of capacitance C is linearly shown approximately similar to FIG. 6.

FIG. 8 shows a graph showing the relationship between a residual amount of methanol and capacitance when the fuel is discharged and injected in the state where the pouch of FIG. 1 overturns. Referring to FIG. 8, when fuel is discharged from or is injected into the pouch 3 in the state where the pouch 3 overturns to connector 34 be disposed on the lower side, it can be appreciated that the residual amount of methanol that is fuel and the change of capacitance C is linearly shown approximately similar to FIG. 6.

In addition, when the fuel cartridge 100 is inclined to one of the first and second long sides L1 and L2, the first and second short side portions 12 and 22 of the first and second electrodes 1 and 2 face each other, thereby making it possible to measure the capacitance C. When the fuel cartridge 100 is inclined to one of the first and second short portions S1 and S2, the first and second long side portions 11 and 21 of the first and second electrodes 1 and 2 face each other, thereby making it possible to measure the capacitance C.

Hereinafter, various exemplary embodiments will be described. The description of the same components as the first exemplary embodiment and the above-mentioned exemplary embodiments will be omitted and different components will be described.

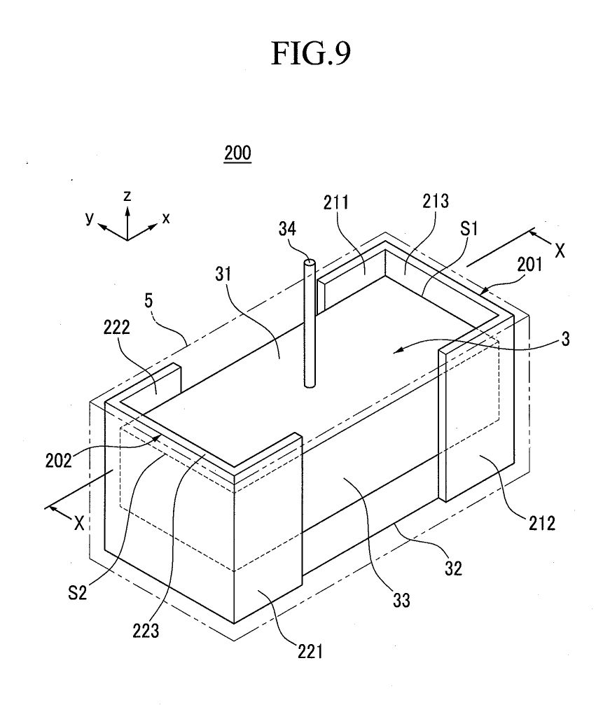

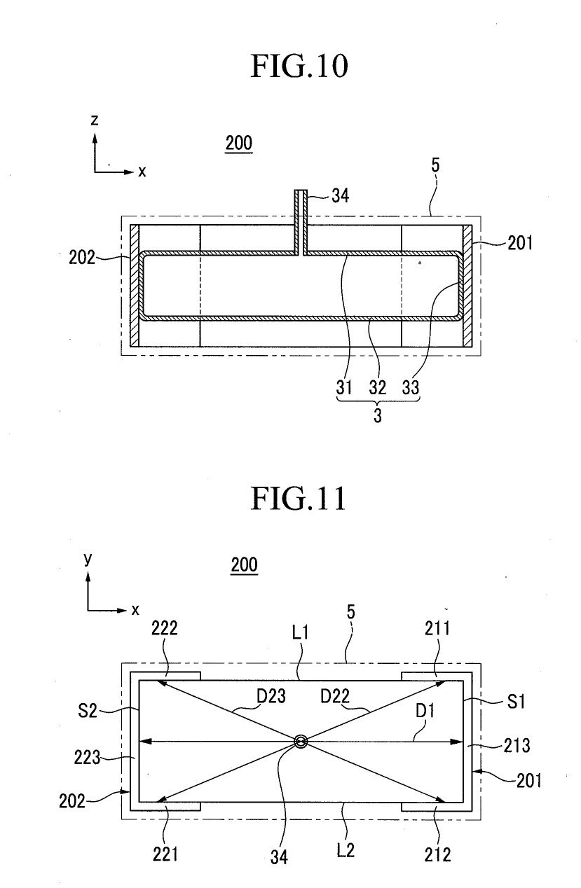

FIG. 9 is a perspective view of a fuel cartridge for a fuel cell according to a second exemplary embodiment. FIG. 10 is a cross-sectional view taken along line X-X of FIG. 9, and FIG. 11 is a plan view of FIG. 9. In the fuel cartridge 100 of the first exemplary embodiment, each of the first and second electrodes 1 and 2 is formed at a right angle and is positioned at two places of the side portion 33 of the pouch 3. In the fuel cartridge 200 of the second exemplary embodiment, each of the first and second electrodes 201 and 202 is formed at two right angles and is positioned at three places of side portions 33 of the pouch 3. That is, one side of the side portion 33 is formed together with a portion of the first and second electrodes 201 and 202. For example, the first electrode 201 includes eleventh and twelfth portions 211 and 212 that are each formed in a plate shape and are parallel with each other and a first short side portion 213 connected thereto at a right angle. The eleventh and twelfth long side portions 211 and 212 are disposed at a portion of the first and second long sides L1 and L2, respectively, of the first and second plane portions 31 and 32 to be adjacent to the first short side S1. The first short side portion 213 is disposed at the first short portion S1 of the first and second plane portions 31 and 32.

The second electrode 202 includes twenty-first and twenty-second long side portions 221 and 222 that are each formed in a plate shape and are parallel with each other and a second short side portion 223 connected thereto at a right angle. The twenty-first and twenty-second long side portions 221 and 222 are disposed at a portion of the first and second long sides L1 and L2, respectively, of the first and second plane portions 31 and 32 to be adjacent to the second short side S2 and face each of the eleventh and twelfth long side portions 211 and 212. The second short side portion 223 is disposed at the second short side S2 of the first and second plane portions 31 and 32 to face the first short portion 213 with the pouch 3 disposed in-between.

As shown in FIG. 11, the first and second electrodes 201 and 202 form the first, second, and third opposite directions D1, D22, and D23. The first opposite direction D1 is parallel with the first and second plane portions 31 and 32 and is set in an x-axis direction. The second and third opposite directions D22 and D23 are parallel with the first and second plane portions 31 and 32 and each intersects with the first opposite direction D1 and with each other. At each surface the side portion 33 of the pouch 3, the first and second electrodes 201 and 202 face each other. Therefore, even when the fuel cartridge 200 is inclined in a specific direction, the fuel is positioned between the first and second electrodes 201 and 202, thereby making it possible to measure the residual amount of fuel.

Hereinafter, in the third to fifth exemplary embodiments, the pouch and the first and second electrodes will be mainly described. In each case, in the third to fifth exemplary embodiments, the configuration of the first, second, and third capacitors set in a z-axis direction is the same as the first and second exemplary embodiments and therefore, the illustration and description thereof will be omitted. In the third to fifth exemplary embodiments, the plane portion established on an xy plane and the disposition of the first and second electrodes will be described.

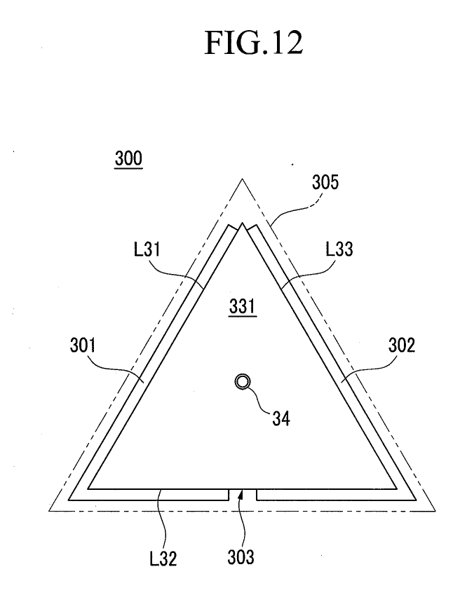

FIG. 12 is a plan view of a fuel cartridge 300 for a fuel cell according to a third exemplary embodiment. Referring to FIG. 12, in the fuel cartridge 300 of the third exemplary embodiment, a pouch 303 is formed in a triangular column. The pouch 303 includes a plane portion 331 having a connector 34 formed approximately at the middle thereof. The plane portion 331 includes a first side L31, a second side L32, and a third side L33 that are sequentially disposed.

A portion of the first and second electrodes 301 and 302 is disposed at each of the first side L31, the second side L32, and the third side L33. For example, the first electrode 301 is bent and is positioned at the first side L31 and the second side L32. As shown, the second electrode 302 is similarly bent and positioned at the third side L33 and at the second side L32.

In the first exemplary embodiment, the first and second electrodes 1 and 2 face each other in a parallel state. In the third exemplary embodiment, the first and second electrodes 301 and 302 face each other in the state where the interval is not parallel with each other, that is, the interval is changed. The first and second electrodes 301 and 302 are set to a number to be divided in a finite interval so that the opposite direction of the first and second electrodes 301 and 302 is set to face each other. In other words, the capacitance between the first and second electrodes 301 and 302 is measured as the sum of capacitance set in the divided finite interval. Therefore, even when the pouch 303 is included in any direction, the first and second electrodes 301 and 302 form a portion where they face each other, thereby making it possible to measure the residual amount of fuel. A housing 305 may be formed in a triangular column corresponding to the shape of the pouch 303.

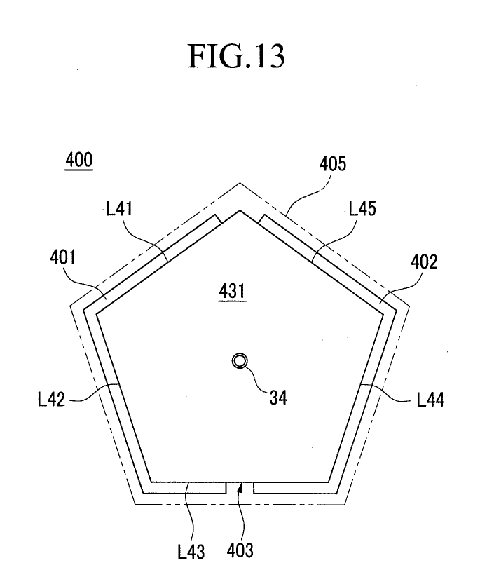

FIG. 13 is a plan view of a fuel cartridge 400 for a fuel cell according to a fourth exemplary embodiment. Referring to FIG. 13, in the fuel cartridge 400 of a fourth exemplary embodiment, a pouch 403 is formed in a pentagonal column and includes a plane portion 431 including the connector 34 at approximately the middle thereof. The plane portion 41 includes a first side L41, a second side L42, a third side L43, a fourth side L44, and a fifth side L45 that are sequentially disposed. A portion of the first and second electrodes 401 and 402 is disposed at each of the first to the fifth sides L41, L42, L43, L44, and L45. For example, the first electrode 401 is bent and is positioned at the first side L41, the second side L42, and the third side L43. The second electrode 402 is similarly bent and is positioned at the third side L43, the fourth side L44 and the fifth side L45. The first and second electrodes 401 and 402 are set as the number divided in the finite interval so that the opposite direction of the first and second electrodes 401 and 402 is set to face each other. The housing 405 may be formed in a pentagonal column corresponding to the shape of the pouch 403.

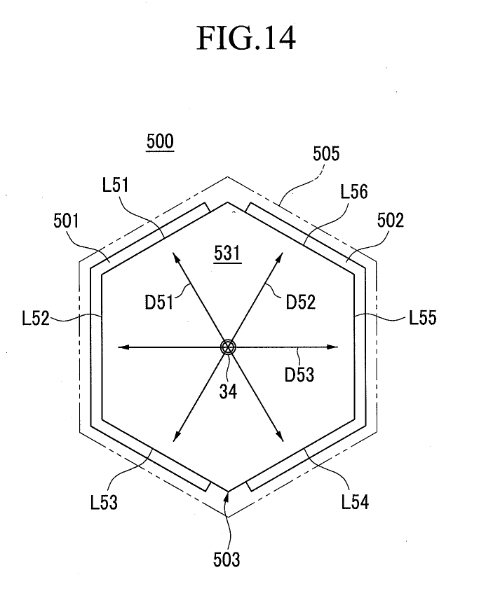

FIG. 14 is a plan view of a fuel cartridge 500 for a fuel cell according to a fifth exemplary embodiment. Referring to FIG. 14, the fuel cartridge 500 of a fifth exemplary embodiment, a pouch 503 is formed in a hexagonal column and includes a plane portion 531 including the connector 34 formed approximately at the middle thereof. The plane portion 531 includes a first side L51, a second side L52, a third side L53, a fourth side L54, a fifth side L55, and a sixth side L56 that are sequentially disposed.

A portion of the first and second electrodes 501 and 502 are disposed at each of the first to sixth sides L51, L52, L53, L54, L55, and L56. For example, the first electrode 501 is bent and is positioned at the first side L51, the second side L52, and the third side L53. Similarly, the second electrode 502 is bent and is positioned at a fourth side L54, a fifth side L55, and a sixth side L56.

FIG. 14 shows the first, second, and third opposite directions D51, D52, and D53, respectively. The first opposite direction D51 is parallel with a plane portion 531 and is set between the first and fourth sides L51 and L54. The second opposite direction D52 is parallel with the plane portion 541 and is set between the second and fifth sides L52 and L55 while intersecting with the first direction D51. The third opposite direction D53 is parallel with the plane portion 541 and is set between the third and sixth sides L53 and L56 while intersecting with the first and second opposite directions D51 and D52. Therefore, even when the fuel cartridge 500 is inclined in a specific direction, fuel is positioned between the first and second electrodes 501 and 502, thereby making it possible to measure the residual amount of fuel. The housing 505 may be in a hexagonal column corresponding to the shape of the pouch 503.

While this disclosure has been described in connection with what are presently considered to be practical exemplary embodiments, it will be appreciated by those skilled in the art that various modifications and changes may be made without departing from the scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the disclosure is not limited to the disclosed embodiments, but, on the contrary, is intended to cover various modifications and equivalent arrangements included within the spirit and scope of the appended claims, and equivalents thereof.

What is claimed is:

1. A fuel cartridge for a fuel cell, comprising:
a housing;
a pouch contained within the housing, wherein the pouch forms an inner space having a first plane portion and a second plane portion parallel with each other, which are mechanically connected to a side portion intersecting therewith, wherein the pouch is configured to contract or expand according to a residual amount of fuel contained within the inner space, and wherein the pouch forms a fuel path on the upper portion thereof; and
first and second electrodes positioned at opposite sides of the side portion and facing each other with the pouch in-between when viewed in a plane,
wherein the first electrode and the second electrode have a plurality of opposite directions.

2. The fuel cartridge of claim 1, wherein the first plane portion and the second plane portion are each formed in a rectangular shape, and wherein the pouch forms a variable rectangular parallelepiped.

3. The fuel cartridge of claim 2, wherein the first electrode comprises a first long side portion formed in a plate shape and positioned at first long sides of the first plane portion and the second plane portion, and a first short side portion formed in a plate shape and mechanically connected to the first long side portion at a right angle, wherein the first short side portion is positioned at a first short side of the first plane portion and the second plane portion, wherein the second electrode comprises a second long side portion formed in a plate shape positioned at second long sides of the first plane portion and the second plane portion and positioned to face the first long side portion, and a second short side portion formed in a plate shape mechanically connected to the second long side portion at a right angle, wherein the second short side portion is positioned at the second short portion of the first plane portion and the second plane portion, and wherein the second short side portion is positioned to face the first short side portion.

4. The fuel cartridge of claim 2, wherein the first electrode comprises an eleventh long side portion and a twelfth long side portion each formed in a plate shape and positioned at a side of a first long side and a second long side of the first plane portion and the second plane portion, respectively; and a first short side portion formed in a plate shape mechanically connected to the eleventh long side portion and the twelfth long side portion at a right angle and is positioned at the first short sides of the first plane portion and the second plane portion, and wherein the second electrode comprises a twenty-first long side portion and a twenty-second long side portion each formed in a plate shape and positioned at the first long side and the second long side of the first plane portion and the second plane portion at an opposite side of the first short side portion and face each of the eleventh long side portion and the twelfth long side portion, and a second short side portion formed in a plate shape mechanically connected to the twenty-first long side portion and the twenty-second portion at a right angle and positioned at the second short sides of the first plane portion and the second plane portion and face the first short side portion.

5. The fuel cartridge of claim 1, wherein the first electrode and the second electrode form a first capacitor, and wherein the fuel stored in the pouch is positioned between the first electrode and the second electrode approximately at the middle of the side portion.

6. The fuel cartridge of claim 5, wherein the first electrode and the second electrode further comprise a second capacitor and a third capacitor, and wherein the second capacitor and the third capacitor are each formed with air between the first electrode and the second electrode at the first plane portion side and the second plane portion side of the pouch.

7. The fuel cartridge of claim 1, wherein the plurality of opposite directions comprises a first opposite direction parallel with the first plane portion and the second plane portion, and a second opposite direction parallel with the first plane portion and the second plane portion and intersects with the first opposite direction.

8. A fuel cartridge for a fuel cell, comprising:
a pouch that connects a pair of plane portions parallel with each other to a side portion intersecting therewith to form an inner space in a shape of a polygonal column, wherein the pouch is configured to contract or expand according to a residual amount of fuel in the inner space; and
a first electrode and a second electrode positioned at opposite sides of the side portion facing each other with the pouch positioned therebetween, wherein the first electrode and the second electrode have a plurality of opposite directions, and wherein at least one of the first electrode and the second electrode is positioned at an entire side of the pair of plane portions.

9. The fuel cartridge of claim 8, wherein the polygonal column shape is formed in one of a triangular column, a quadrangular column, a pentagonal column, and a hexagonal column.

10. The fuel cartridge of claim 8, wherein the pouch is formed in a triangular column and forms the plane portion in a triangular shape having a first side, a second side, and a third side that are sequentially disposed, wherein the first electrode is positioned at the first side and the second side, and wherein the second electrode is positioned at the third side.

11. The fuel cartridge of claim 10, wherein the second electrode is further positioned at the second side.

12. The fuel cartridge of claim 8, wherein the pouch is formed in a pentagonal column and forms the plane portion in a pentagonal shape having a first side, a second side, a third side, a fourth side, and a fifth side that are sequentially disposed, wherein the first electrode is positioned at the first side, the second side, and the third side, and wherein the second electrode is positioned at the fourth side and the fifth side.

13. The fuel cartridge of claim 12, wherein the second electrode is further positioned at the third side.

14. The fuel cartridge of claim 8, wherein the pouch is formed in a hexagonal column and forms the plane portion in a hexagonal shape having a first side, a second side, a third side, a fourth side, a fifth side, and a sixth side that are sequentially disposed, wherein the first electrode is positioned at the first side, the second side, and the third side, and wherein the second electrode is disposed at the fourth side, the fifth side, and the sixth side.
